(19) United States
(12) Patent Application Publication
(10) Pub. No.: US 2005/0248795 A1
(43) Pub. Date: Nov. 10, 2005

(54) Apparatus, system, and method for print adjustment

(76) Inventor: Kevin Hunter Vorhees, Raleigh, NC (US)

Correspondence Address: KUNZLER & ASSOCIATES, 8 EAST BROADWAY, SUITE 600, SALT LAKE CITY, UT, 84111, US

(21) Appl. No.: 10/841,167

(22) Filed: May 7, 2004

(51) Int. Cl. G06F 15/00

(52) U.S. Cl. 358/1.13; 358/504

(57) ABSTRACT

An apparatus, system and method of print adjustment are provided under the invention a printed image that was printed in response to a print command is scanned. A correction factor is then calculated responsive to the printed image scan and the print command. The correction factor is then applied to a subsequent print command to form an adjusted print command. The adjusted print command causes the image to be printed in the proper manner as specified by the print command. The correction factor may be stored and applied to the subsequent print command. In one embodiment, the correction factor is calculated from the print command, the printed image scan, and a pre-existing correction factor.

### BACKGROUND OF THE INVENTION

1. Field of the Invention

This invention relates to print adjustment and more particularly relates to print adjustment from a printed image scan.

2. Description of the Related Art

A printer renders a logical description of an image such as text, art, or a picture as a printed image. The printer typically receives the logical description as a print command. The print command details the appearance of the printed image as rendered on a page. In one arrangement, the print command specifies the arrangement of a dot matrix.

Under certain circumstances, the printer may fail to render the print command in a manner that accurately produces the logical description of the image. For example, printers often use mechanical components designed to render the printed image in the locations and with the tones described by the print command. These mechanical components are subject to wear, however, and component wear can cause print variance, which is the difference between the printer's rendering of the printed image and the logical description of the print command. Differences in mechanical and electrical printer components, differences in, in ink including viscosity and drying rates, and differences in paper including smoothness, grain size, grain direction, and coating type may also cause print variance in new printers. Print variance may also be caused by damage to the components of the printer during shipping and handling. Additional print variance may result from changes in temperature, humidity, and barometric pressure.

Many prior art printers allow operators to manually adjust the printer in order to accurately render printed images of print commands. However, manual adjustment by an operator can be time consuming and may require special knowledge. Manual adjustment may also not be practical if the printer develops a print variance after the printer has left the factory. Printers have been designed that estimate mechanical wear and automatically adjust the printer to compensate for the wear. However, estimations of mechanical wear are not always accurate and do not detect variations due to manufacturing and shipping.

From the foregoing discussion it should be apparent that a need exists for a process, apparatus, and system for print adjustment specific to the print variance of a printer. Beneficially, such a process, apparatus, and system would maintain the accuracy of printed images rendered by the printer.

### SUMMARY OF THE INVENTION

The present invention has been developed in response to the present state of the art, and in particular, in response to the problems and needs in the art that have not yet been fully solved by currently available printing systems. Accordingly, the present invention has been developed to provide a method, apparatus, and system for print adjustment that overcome many or all of the above-discussed shortcomings in the art.

The apparatus for print adjustment is provided with a logic unit containing a plurality of modules configured to functionally execute the necessary steps of print adjustment. These modules in the described embodiments include a print control module and an adjustment module. The print control module receives a print command describing an image and directs the print command to a printer module. In one embodiment, the print control module directs the print command to the printer module by modifying the print command for the specific characteristics of the printer module. The print control module further communicates the print command to the printer module, and the printer module then prints the image. In one embodiment, the adjustment module commands a scanner to scan the printed image. The printed image may be scanned while being transported through the printer module. In an alternate embodiment, a user manually scans the printed image.

The adjustment module receives the printed image scan and compares the print command and the printed image scan. In addition, the adjustment module calculates a correction factor. In one embodiment, the adjustment module calculates the correction factor in response to a user command. The print control module applies the correction factor applied to a subsequent print command to form an adjusted print command. The printer module prints the adjusted print command as a printed image conforming to the image as specified by the print command. In one embodiment, the adjustment module includes an existing correction factor in calculating the correction factor. The print control module stores the correction factor and applies the correction factor to the subsequent print command.

A system of the present invention is also presented for print adjustment. The system may be embodied in a printer/scanner system such as copier/printer/scanner/fax machine. In particular, the system, in one embodiment, includes a scanner and a printer. The printer prints a printed image in response to a print command. The scanner scans the printed image and communicates the printed image scan to the printer. In one embodiment, the printed image is scanned while being transported through the printer. In an alternate embodiment, a user manually places the printed image on the scanner and initiates the scan. In a certain embodiment, the printed image is scanned in response to a user command.

The printer compares the print command and the printed image scan and calculates a correction factor. In one embodiment, the printer calculates the correction factor in response to the user command. The printer may store the correction factor and apply the correction factor to a subsequent print command.

In one embodiment, the printer prints a dot matrix. In another embodiment, the printer is an impact printer and the printer adjusts the firing timing of the print head wire in response to the correction factor. In an alternate embodiment, the printer is a laser printer. The laser printer may adjust the firing of the laser in response to the correction factor. In a further embodiment, the printer is an ink jet printer and adjusts the ink stream of the print head in response to the correction factor. The printer may also be a thermal printer and adjust the position and the thermal characteristics of the thermal print head.

A method of the present invention is also presented for print adjustment. The method in the disclosed embodiments substantially includes the steps necessary to carry out the functions presented above with respect to the operation of the described apparatus and system. In one embodiment, the method includes receiving a print command, printing the print command, scanning the printed image, comparing the print command and the printed image scan, calculating a correction factor, and applying the correction factor.

The method then involves receiving a print command. In one embodiment, the print command is included in a print job. In an alternate embodiment, the print command is received from a calibration process. The image described by the print command is printed and the printed image is scanned. In addition, the method calculates a correction factor using the print command the printed image scan. The method applies the correction factor to a subsequent print command to form an adjusted print command.

An alternate method of the present invention is also presented for print adjustment. The alternate method includes receiving the print command, applying the correction factor to a subsequent print command to form an adjusted print command, and printing the adjusted print command.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

The present invention involves scaning a printed image printed from a print command and calculating a correction factor from the print command and the printed image scan. The correction factor is applied to a subsequent print command to form an adjusted print command that renders the image described by the print command. The present invention may correct print variance due to mechanical wear, manufacturing differences, or shipping and handling damage. Thus, printing may be conducted in a manner that is more accurate without requiring intervention of a user. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating one embodiment of a print adjustment apparatus in accordance with the present invention;

FIG. 2 is a drawing illustrating one embodiment of a printed image scan/print command difference in accordance with the present invention;

FIG. 3 is a block diagram illustrating one embodiment of a print adjustment system of the present invention;

FIG. 4 is a perspective view of one embodiment of a printer/scanner system of the present invention;

FIG. 5 is a partially schematic side view of one embodiment of an in-line scanner of the present invention;

FIG. 6 is a flow chart diagram illustrating one embodiment of a correction factor calculation method in accordance with the present invention;

FIG. 7 is a flow chart diagram illustrating one embodiment of a print adjustment method in accordance with the present invention; and

FIG. 8 is a block diagram of one embodiment of a print adjustment scanner of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form cat and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

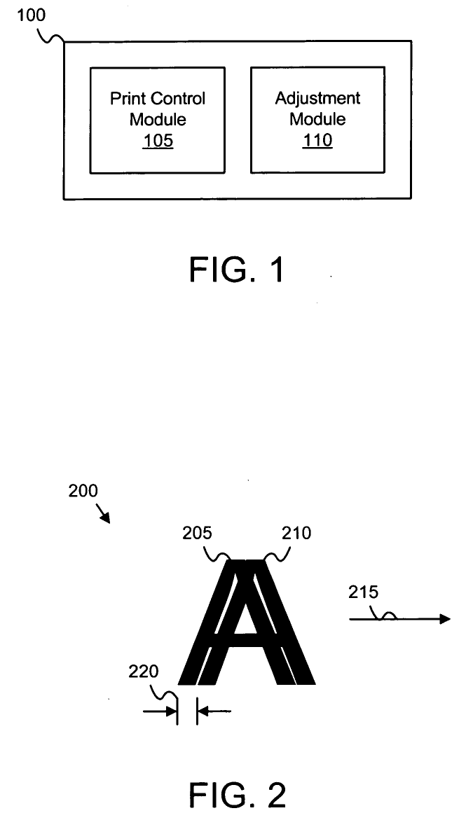

FIG. 1 is a block diagram illustrating one embodiment of a print adjustment apparatus 100 in accordance with the present invention. The print adjustment apparatus 100 calculates a correction factor from a print command and a printed image scan. As depicted, the print adjustment apparatus 100 includes a print control module 105 and an adjustment module 110. In one embodiment, the print adjustment apparatus 100 is a component of a printer (not shown) that includes a printer module (not shown) configured to render the print command.

The print control module 105 receives a print command specifying an image and directs the print command to a printer module. The print control module 105 may direct the print command to the printer module by modifying the print command for the specific characteristics of the printer module. In one embodiment, the print command describes a dot matrix. As used herein the term “dot matrix” is intended to mean one or more dots, arcs, squares, lines, areas, and images or combinations of dots, arcs, squares, lines, areas and images printed upon print media. Also as used herein, the term “print media” is intended to mean paper, transparencies, forms, labels, and structures. The print command may include a position component. In addition, the print command may include a tone component. The print control module 105 further communicates the print command to the printer module and the printer module prints the printed image on the print media.

In one embodiment, the adjustment module 110 commands a scanner to scan the printed image. The adjustment module 110 may command the scanner to scan the printed image in response to a user command. In a certain embodiment, the adjustment module 110 periodically commands the scanner to scan a printed image. For example, the adjustment module 110 may command the scanner to scan a printed image each week. The printed image may be scanned while being transported through the printer module.

The adjustment module 110 receives the printed image scan and compares the print command and the printed image scan. In addition, the adjustment module 110 calculates a correction factor from the differences between the print command and the printed image scan. The correction factor may include a position component. In addition, the correction factor may also include a tone component. As used herein, tone may refer to the shade, texture, and color of a printed image. In one embodiment, the adjustment module 110 calculates the position component of the correction factor from the differences in the positions of the printed image and the print command along the axis of the motion of the print element across a print media. The print element may be a print head, and without limitation may be an impact print head, a thermal print head, or an ink jet print head. In a further embodiment, the print element is a guided laser beam.

In a certain embodiment, the adjustment module 110 calculates the correction factor. The correction factor is composed of at least one component including but not limited to position, tone, angle, darkness, scale, and color tone. For example, the adjustment module 110 may calculate the position component of the correction factor from one or more differences between the positions of the print command and the printed image scan along the axis of the motion of the print media. The adjustment module 110 may also calculate the position component of the correction factor from differences between the print command and the printed image scan along the vertical and horizontal axes of the plane of the print media. In a certain embodiment, the adjustment module 110 may calculate the darkness component of the correction factor from the differences in the darkness of the print command and the printed image scan. In one embodiment, the adjustment module 110 calculates the scale component of the correction factor from the difference in scales between the print command and the printed image scan. The adjustment module 110 may also calculate the angle component of the correction factor from differences in the orientation angle of the print command and the printed image scan and calculate the color tone component from differences in color tone between the print command and the printed image scan. The adjustment module 110 may store the correction factor.

The print control module 105 receives the correction factor from the adjustment module 110. In one embodiment, the print control module 105 applies the correction factor to a subsequent print command to form an adjusted print command. The print control module 105 may also apply the correction factor to the current print command and reprint the printed image with the adjusted print command. The applied correction factor modifies the print command such that the printer module prints the adjusted print command as a printed image as described by the print command. In one embodiment, the print control module 105 applies the correction factor to the print command by summing the one or more components of the print command and the correction factor. For example, the print control module 105 may sum the position component of the print command and the position component of the correction factor to adjust the print command.

In one embodiment, the adjustment module 110 stores a pre-existing correction factor that was applied to the print command when the printer module printed the printed image from the print command. The adjustment module 110 may subtract the pre-existing correction factor from the one or more differences between the print command and the printed image scan when calculating the correction factor. The print adjustment apparatus 100 creates a correction factor from the printed image scan and the print command and applies the correction factor to one or more print commands to correct print variance.

FIG. 2 is a drawing illustrating one embodiment of a printed image scan/print command difference (“PISPCD”) 200 in accordance with the present invention. The PISPCD 200 as depicted includes a printed image scan 205, a print command 210 describing an image, a print element motion axis 215, and a position difference 220. The PISPCD 200 shows the logical relations between the printed image scan 205, the image described by the print command 210, the print element motion axis 215, and the position difference 220, and may not represent physical elements.

The printed image scan 205 represents a scanned printed image of the print media. In one embodiment, the printed image was printed on the print media by a print element moving in the direction of the print element motion axis 215. As printed, the printed image was intended to occupy the position of the image specified by the print command 210. The positions of the printed image scan 205 and the image specified by the print command 210 differ by the position difference 220. The position difference 220 is a print variance.

In one embodiment, the position difference 220 is detected by the adjustment module 110 and used as a component of the correction factor. Applying the correction factor to a subsequent print command forms an adjusted print command that reduces the print variance by reducing the position difference 220.

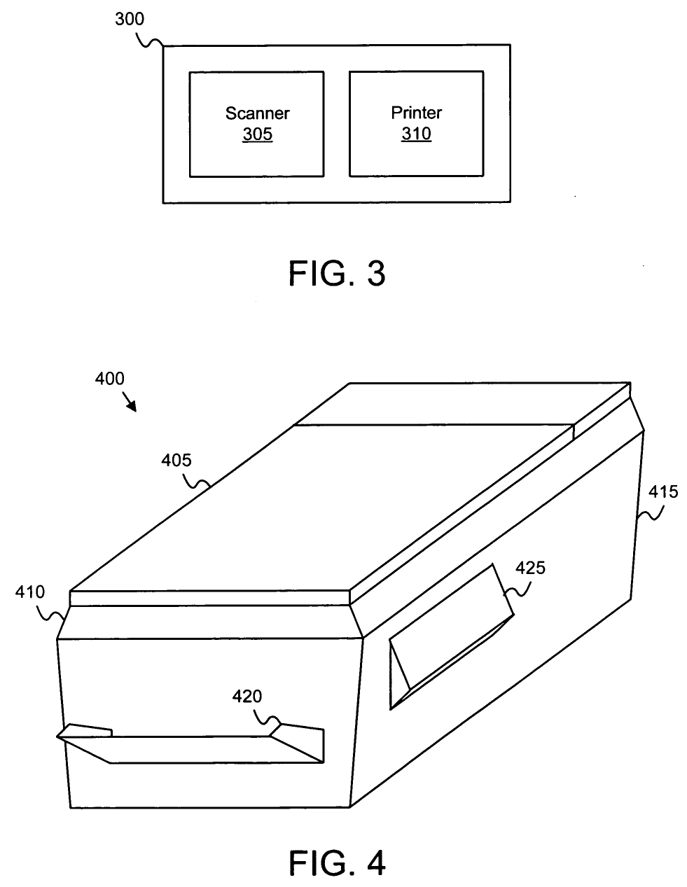

FIG. 3 is a block diagram illustrating one embodiment of a print adjustment system 300 of the present invention. The print adjustment system 300 calculates a correction factor and applies the correction factor to a print command 210 to reduce print variance. The print adjustment system 300 includes a scanner 305 and a printer 310. In one embodiment, the print adjustment system 300 is a printer/scanner machine. In an alternate embodiment, the print adjustment system 300 is a printer 310 with an integrated in-line scanner 305. The printer 310 may include the print adjustment apparatus 100 of FIG. 1.

The printer 310 prints a printed image in response to the print command 210. The scanner 305 scans the printed image and communicates the printed image scan 205 to the printer 310. In one embodiment, the printed image is scanned while it is transported through the printer 310. In an alternate embodiment, a user manually places the printed image on the scanner 305 and initiates the scan.

The printer 310 compares the print command 210 and the printed image scan 205 and calculates a correction factor. In one embodiment, the printer 310 calculates the correction factor in response to the user command. The printer 310 may apply the correction factor to a subsequent print command to form an adjusted print command. In addition, the printer 310 may apply the correction factor to the current print command 210 and reprint the current print command 210.

In one embodiment, the printer 310 is an impact printer and the printer 310 adjusts the firing timing of the print head wire in response to the correction factor. In an alternate embodiment, the printer 310 is a laser printer. The printer 310 may adjust the firing of the laser in response to the correction factor. In a certain embodiment, the printer 310 is an ink jet printer and adjusts the ink stream of the print head in response to the correction factor. The printer 310 may also be a printer and adjust the position and the thermal characteristics of the thermal print head. The print adjustment system 300 reduces print variance by calculating the correction factor and applying the correction factor to a print command 210 to form an adjusted print command.

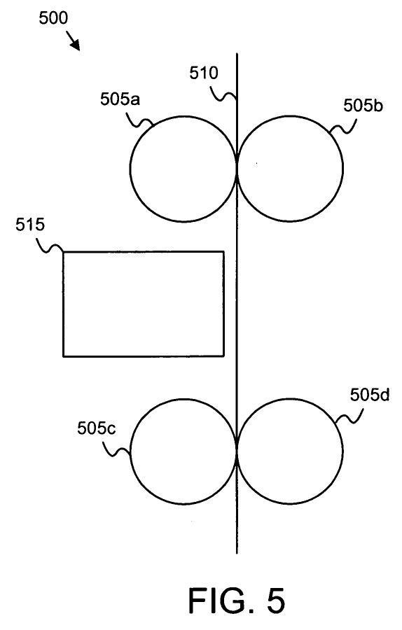

FIG. 4 is a perspective drawing of one embodiment of a printer/scanner system 400 of the present invention. The printer/scanner system 400 may function as a copy machine, printer, scanner, and fax machine. The printer/scanner system 400 includes a scanner cover 405, a scanner portion 410, a printer portion 415, a paper tray 420, and a control panel 425. The printer/scanner system may also include the print adjustment apparatus 100 of FIG. 1.

The printer portion 415 prints a printed image on a print media in response to a print command 210. In one embodiment, the print command 210 is a fax input. In an alternate embodiment, the print command 210 is a scan input. In one embodiment, a user retrieves the print media from the paper tray 420, lifts the scanner cover 405, and places the print media on the scanner portion 410. In an alternate embodiment, the printer portion 415 prints the printed image on the print media and transports the print media to the scanner portion 410. The user may further issue a command using the control panel 425 for the scanner portion 410 to scan the print media. In one embodiment, the scanner portion 410 automatically scans the print media. The scanner portion 410 scans the printed image on the print media and the printer/scanner system 400 calculates a correction factor from the print command 210 and the printed image scan 205.

The printer/scanner system 400 may apply the correction factor to a subsequent print command to form an adjusted print command and print the adjusted print command to reduce the print variance of the printed image. In one embodiment, the printer/scanner system 400 calculates the correction factor as a calibration.

FIG. 5 is a partially schematic illustration of one embodiment of an in-line scanner 500 of the present invention. The in-line scanner 500 scans a printed image on a print media 510 transported through a printer 310. The in-line scanner 500 includes one or more rollers 505, the print media 510, and a scanner 515. In one embodiment, the depicted elements are components of the printer 310 of FIG. 3. The rollers 505 transport the print media 510 through the printer 310. The scanner 515 scans the print media 510 as the print media 510 is transported. The scanner 515 may scan the printed image on the print media 510 and communicate the printed image scan 205. In one embodiment, the in-line scanner 515 communicates the printed image scan 205 to the adjustment module 110 depicted in FIG. 1.

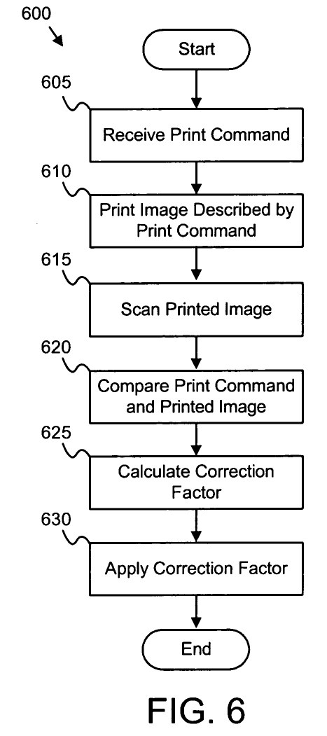

FIG. 6 is a flow chart diagram illustrating one embodiment of a correction factor calculation method (“CFCM”) 600 in accordance with the present invention. The CFCM 600 calculates a correction factor from a printed image scan 205 and a print command 210. Although for purposes of clarity the CFCM 600 is depicted in a certain sequential order, execution may be conducted in parallel and not necessarily in the depicted order.

The CFCM 600 receives 605 a print command 210 and prints 610 the image described by the print command 210. In one embodiment, the print command 210 is included in a print job. In an alternate embodiment, the print command 210 is received 605 from a calibration process. The print command 210 may specify a dot matrix image. The CFCM 600 further scans 615 the printed image 205 printed from the print command 210 and compares 620 the print command 210 and the printed image scan 205. In one embodiment, the CFCM 600 compares 620 the print command 210 and printed image scan 205 along the print element motion axis 215. In an alternate embodiment, the CFCM 600 compares the print command 210 and the printed image scan 205 along the horizontal and vertical axes of the plane of the print media 510.

The CFCM 600 calculates 625 a correction factor from the print command 210 and the printed image scan 205. In one embodiment, the correction factor includes the position difference 220 between the logical positions of the printed image scan 205 and the print command 210. The correction factor may include the difference between the tone of the printed image scan 205 and the tone of the print command 210. In a certain embodiment, the CFCM 600 calculates 625 the correction factor from the printed image scan 205, the print cat command 210, and a pre-existing correction factor. The CFCM 600 applies 630 the correction factor to a subsequent print command to form an adjusted print command. In one embodiment, the subsequent print command is the print command 210 used to calculate the correction factor. The printed adjusted print command renders the printed image as described by the print command 210, correcting a print variation. In one embodiment, the CFCM 600 is used to calibrate a printer 310.

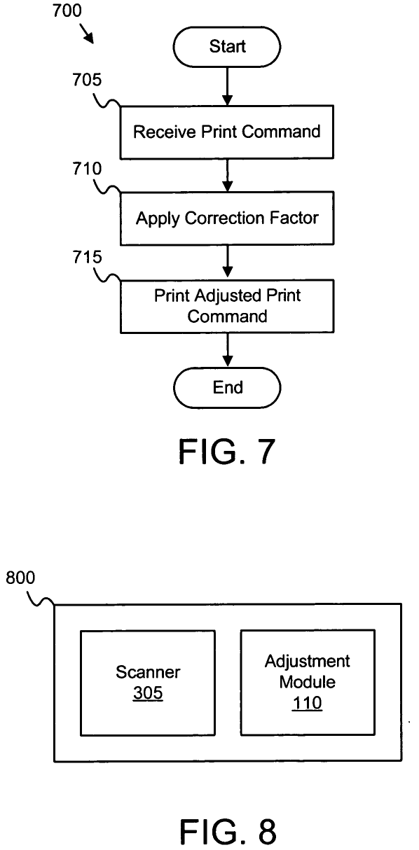

FIG. 7 is a flow chart diagram illustrating one embodiment of a print adjustment method (“PAM”) 700 in accordance with the present invention. The PAM 700 applies a correction factor to a print command 210. Although for purposes of clarity the PAM 700 is depicted in a certain sequential order, execution may be conducted in parallel and not necessarily in the depicted order.

The PAM 700 receives 705 a print command 210 and applies 710 a correction factor to the print command 210 to form an adjusted print command. In one embodiment, the print command 210 includes a position component and a tone component. The PAM 700 may apply 710 the correction factor by summing the components of the print command 210 and the correction factor to form the adjusted print command. In addition, the PAM 700 prints 715 the adjusted print command. Printing 715 the adjusted print command renders a printed image as described by the print command 210, reducing a print variation.

FIG. 8 is a block diagram of one embodiment of a print adjustment scanner 800 of the present invention. The print adjustment scanner 800 receives a print command 210. In addition, the scanner 305 scans a printed image of the image described by the print command 210. The scanner 305 may scan the printed image in response to a user command. The scanner 305 may also scan the printed image under the direction of the adjustment module 110. The adjustment module 110 calculates a correction factor from the print command 210 and the printed image scan 205. In one embodiment, the correction factor is communicated to a computer. The computer may apply the correction factor to a subsequent print command to form an adjusted print command and communicate the adjusted print command to a printer 310.

The present invention scans a printed image printed from a print command 210 and calculates a correction factor from the print command 210 and the printed image scan 205. The present invention further applies the correction factor to a subsequent print command 210 to form an adjusted print command. The present invention in certain described embodiments reduces print variance between the print command 210 and the printed image due to differences in mechanical and electrical components, mechanical wear, manufacturing differences, shipping and handling damage, differences in inks including viscosity and drying rates, differences in print media types including smoothness, grain size, grain direction, and coating type, and changes in temperature, humidity, and barometric pressure. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A print adjustment apparatus comprising:
a print control module configured to receive a print command, direct the print command to a printer module, and communicate the print command to the printer module, the print control module further configured to receive a correction factor, to store the correction factor, and to apply the correction factor to a subsequent print command to form an adjusted print command; and
an adjustment module configured to receive the print command and a printed image scan of the printed image, compare the print command and the printed image scan, and calculate the correction factor such that the correction factor applied to the print command forms the adjusted print command that prints the image as specified by the print command using the printer module.

2. The apparatus of claim 1, wherein the printer module is configured to print a dot matrix.

3. The apparatus of claim 2, wherein the printer module is an impact printer configured with a print head wire, and wherein the correction factor adjusts the firing timing of the print head wire.

4. The apparatus of claim 1, wherein the printer module is a laser printer and the correction factor adjusts the firing of the laser.

5. The apparatus of claim 1, wherein the correction factor adjusts the position of the print head.

6. The apparatus of claim 1, wherein the correction factor adjusts the position of the print media.

7. The apparatus of claim 1, wherein the adjustment module calculates the correction factor using an existing correction factor.

8. The apparatus of claim 1, wherein the adjustment module is further configured to calibrate the printer module by directing the printing of a specified print command, scanning the printed image of the specified print command, and calculating the correction factor from the specified print command and the printed image scan.

9. An print adjustment scanner, the scanner comprising:
a scan module configured to scan a printed image; and
an adjustment module configured to receive a print command and the printed image scan, compare the print command and the printed image scan, and calculate a correction factor such that the correction factor applied to the print command forms an adjusted print command that prints the image as specified by the print command.

10. The print adjustment scanner of claim 9, wherein the adjustment module is configured to communicate the correction factor to a computer, and the computer is configured to store the correction factor, apply the correction factor to a subsequent print command to form the adjusted print command, and communicate the adjusted print command to a printer.

11. A system for print adjustment, the system comprising:
a scanner configured to scan a printed image and communicate the printed image scan; and
a printer configured to receive a print command describing an image, print the printed image of the print command, receive the printed image scan from the scanner, compare the print command and the printed image scan, and calculate a correction factor such that the correction factor applied to the print command forms an adjusted print command that prints the image as specified by the print command, the printer further configured to store and apply the correction factor to a subsequent print command.

12. The system of claim 11, wherein the printer is configured to print a dot matrix.

13. The system of claim 11, wherein the printer is an impact printer.

14. The system of claim 13, wherein the impact printer is configured to adjust the firing timing of the print head wire responsive to the correction factor.

15. The system of claim 11, wherein the printer is a laser printer.

16. The system of claim 11, wherein the printer is an ink jet printer.

17. The system of claim 11, wherein the printer is a thermal printer.

18. The system of claim 11, wherein the printed image is mechanically transported to the scanner.

19. The system of claim 11, wherein the printed image is manually transported to the scanner and scanned responsive to a user command.

20. A computer readable storage medium comprising computer readable code configured to:
receive a print command;
print a printed image described by the print command;
scan the printed image;
compare the print command and the printed image scan;
calculate a correction factor wherein the correction factor applied to the print command prints the image as specified by the print command; and
apply the correction factor to a subsequent print command to form an adjusted print command.

21. The computer readable storage medium of claim 20, the computer readable code further configured to adjust the firing timing of a print head wire of an impact printer responsive to the correction factor.

22. The computer readable storage medium of claim 20, the computer readable code further configured to adjust the firing of a laser of a laser printer responsive to the correction factor.

23. The computer readable storage medium of claim 20, the computer readable code further configured to adjust the pulsing of an ink stream responsive to the correction factor.

24. The computer readable storage medium of claim 20, the computer readable code further configured to direct the transport of the printed image to the scanner and the scanning of the printed image by the scanner.

25. The computer readable storage medium of claim 20, the computer readable code further configured to direct the scanning of the printed image responsive to a user command.

26. The computer readable storage medium of claim 20, the computer readable code further configured to print a specified print command, direct the scanning of the printed image of the specified print command, and calculate the correction factor as a calibration.

27. A computer readable storage medium comprising computer readable code configured to:
receive a print command describing an image;
apply a correction factor to the print command to form an adjusted print command; and
print the adjusted print command.

28. A method for print adjustment, the method comprising:
receiving a print command;
printing a printed image specified by the print command;
scanning the printed image;
comparing the print command and the printed image scan;
calculating a correction factor wherein the correction factor applied to the print command prints the image as specified by the print command; and
applying the correction factor to a subsequent print command to form an adjusted print command.

29. The method of claim 28, wherein the method comprises adjusting the firing timing of a print head wire of an impact printer responsive to the correction factor.

30. An apparatus for print adjustment, the apparatus comprising:
means for receiving a print command;
means for printing a printed image specified by the print command;
means for scanning the printed image;
means for comparing the print command and the printed image scan;
means for calculating a correction factor wherein the correction factor applied to the print command prints the image as specified by the print command; and
applying the correction factor to a subsequent print command to form an adjusted print command.
